(19) United States
(12) Patent Application Publication
(10) Pub. No.: US 2018/0118175 A1
(43) Pub. Date: May 3, 2018

(54) PRESSURE RELIEF DESIGNS FOR VEHICLE BRAKING SYSTEM TO PREVENT INJURIES

(71) Applicant: Fred S. Stockbauer, Wimberley, TX (US)

(72) Inventor: Fred S. Stockbauer, Wimberley, TX (US)

(21) Appl. No.: 15/696,720

(22) Filed: Sep. 6, 2017

Related U.S. Application Data
(60) Provisional application No. 62/495,197, filed on Sep. 6, 2016.
(60) Provisional application No. 62/482,418, filed on Apr. 6, 2017.

(51) Int. Cl. B60T 7/06; B60T 13/68; B60T 13/66; B60T 13/58; B60T 15/36

(52) U.S. Cl. CPC B60T 7/065; B60T 13/68; B60T 13/662; B60T 2270/88; B60T 15/36; B60T 2220/04; B60T 13/581

(57) ABSTRACT

In some embodiments, a system and/or method may reduce certain injuries resulting from a vehicle collision. The method may include opening a valve in a pressurized brake line of a brake system of a vehicle in response to a trigger. The trigger may include a set pressure value of a fluid in the pressurized brake line. The method may include allowing the fluid in the pressurized brake line to flow through a sized opening accessible through the opened valve. The sized opening may reduce a fluid pressure in the pressurized brake line verses time. The sized opening may be dimensioned to allow a flow rate of the fluid conveying through the sized opening such that the fluid pressure reduces over a period of time. The method may include reducing backpressure on a brake pedal coupled to the pressurized brake line.

### PRIORITY CLAIM

This application claims priority to U.S. Provisional Patent Application No. 62/495,197 entitled “HYDRAULIC PRESSURE RELIEF VEHICLE BRAKING SYSTEM” filed on Sep. 6, 2016, and U.S. Provisional Patent Application No. 62/482,418 entitled “PRESSURE RELIEF DESIGNS FOR VEHICLE BRAKING SYSTEM TO PREVENT INJURIES” filed on Apr. 6, 2017, both of which are incorporated by reference herein.

### BACKGROUND OF THE INVENTION

### 1. Field of the Invention

The present disclosure generally relates to vehicle safety systems. More particularly, the disclosure generally relates to systems and methods for reducing backpressure on brake pedals during a vehicular collision.

### 2. Description of the Relevant Art

Lower extremity injuries, in particular the foot/ankle are one of the most common in automotive crashes. Although not life threatening, they can lead to long term medical complications or permanent disability. In most cases foot and/or ankle fractures are caused during frontal automotive crashes, while the driver attempts an emergency braking and the foot is subject to crash loading. During the crash, the pedal may induce dorsiflexion and axial loading of the ankle due to forward motion of the occupant and rearward intrusion of the pedal relative to the vehicle. In these cases, fractures of the forefoot, in particular the metatarsals are very common and range from simple fractures to severe crush injuries.

In these situations, the drivers body mass moves forward, reaching a sudden stop with the brake pedal applying extreme pressure on the foot and leg. This action causes injuries to the ankle, leg, joints, and/or pelvic areas. These decelerations are measured from 30 to 60 g's resulting in forces of a thousand pounds, or more, applied to these areas. This is especially true with shorter individuals whose leg is fully extended during braking, and knee flexing does not occur. These brake forces may occur even before the seat belts and airbags activate retarding the driver's forward motion, since these restraints are applied to the upper body.

In collision situations, the driver applies the brake pedal with maximum effort and the brake shoes are fully in contact against the brake drums, or brake pads against the brake disks. Therefore, the pedal reaches a “hard stop”, due to the non-compression of the brake fluid.

Accordingly, there exists a need, heretofore unfulfilled, for a system and/or method for use in a vehicle that reduces the intrusion forces imparted to the occupant by the brake pedal.

### SUMMARY

In some embodiments, a system and/or method may reduce certain injuries resulting from a vehicle collision. The method may include opening a valve in a hydraulic line of a brake system of a vehicle in response to a trigger. The trigger may include a set pressure value of a fluid in the pressurized brake line. The method may include allowing the fluid in the pressurized brake line to flow through a sized opening accessible through the opened valve. The sized opening may reduce a fluid pressure in the pressurized brake line verses time. The sized opening may be dimensioned to allow a flow rate of the fluid conveying through the sized opening such that the fluid pressure reduces over the predetermined time period which allows for using a maximum amount of a distance. The distance may be from the brake pedal to a floor pan of the vehicle. The predetermined time period is a duration of a vehicle collision. The predetermined period of time may be from about 80 to about 100 milliseconds. A majority of collisions involving injury occur in less than 200 milliseconds. The method may include reducing backpressure on a brake pedal coupled to the brake hydraulic line.

In some embodiments, the set pressure value is greater than a pressure value required to lock the brakes of the vehicle.

In some embodiments, the method includes inhibiting the flow of the fluid through the sized opening to the extent that stopping the vehicle is not inhibited.

In some embodiments, the sized opening allows for a flow rate of the fluid through the sized opening to be adjustable as a function of pressure.

In some embodiments, the brake system comprises a hydraulic braking system and/or an air braking system.

In some embodiments, the method includes collecting the fluid conveyed through the sized opening in a container (e.g., a brake cylinder reservoir) hydraulically coupled to the valve.

In some embodiments, the method includes reducing backpressure on a brake pedal coupled to the hydraulic brake line in a controlled manner.

In some embodiments, the method includes coupling the valve to the brake line using a “T” fitting.

In some embodiments, a system may include a valve and sized opening which accomplishes the method as described herein.

### BRIEF DESCRIPTION OF THE DRAWINGS

Advantages of the present invention may become apparent to those skilled in the art with the benefit of the following detailed description of the preferred embodiments and upon reference to the accompanying drawings.

FIG. 1 depicts an embodiment of a system for reducing backpressure in a braking system including a valve and a sized opening.

FIG. 2 depicts an embodiment of a system for reducing backpressure in a braking system including a valve and an expandable bellows.

FIG. 3 depicts an embodiment of a system for reducing backpressure in a braking system including a valve and hydraulic expansion cylinder.

FIG. 4 depicts an embodiment of a system for reducing backpressure in a braking system including an electronically triggered valve.

FIG. 5 depicts an embodiment of a system for reducing backpressure in a braking system using computer control based on pedal motion and a force sensor.

FIG. 6 depicts a calculated probability of injury relative to speed of a compact vehicle involved in a collision for a 132 pound female driver as a brake pedal deflection is increased.

FIG. 7 depicts a calculated probability of injury relative to speed of an intermediate size vehicle involved in a collision for a 132 pound female driver as a brake pedal deflection is increased.

FIG. 8 depicts a calculated probability of injury relative to speed of a full size vehicle involved in a collision for a 132 pound female driver as a brake pedal deflection is increased.

FIG. 9 depicts a calculated probability of injury relative to speed of a compact size vehicle involved in a collision for a 165 pound male driver as a brake pedal deflection is increased.

FIG. 10 depicts a calculated probability of injury relative to speed of an intermediate size vehicle involved in a collision for a 165 pound male driver as a brake pedal deflection is increased.

FIG. 11 depicts a calculated probability of injury relative to speed of a full size vehicle involved in a collision for a 165 pound male driver as a brake pedal deflection is increased.

FIG. 12 depicts a calculated time of collision relative to a speed of a variety of differently sized vehicles.

FIG. 13 depicts calculated relief valve flow coupled to a 0.0025 in². opening depicted as a flow rate (in³/sec) verses pressure (psi).

FIG. 14 depicts a calculated master cylinder piston travel (in.) verses time (sec.) using an opening that is 0.0025 in².

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicated open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third die electrically connected to the module substrate” does not preclude scenarios in which a “fourth die electrically connected to the module substrate” is connected prior to the third die, unless otherwise specified. Similarly, a “second” feature does not require that a “first” feature be implemented prior to the “second” feature, unless otherwise specified.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

It is to be understood the present invention is not limited to particular devices or mechanical systems, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Thus, for example, reference to “a linker” includes one or more linkers.

### DETAILED DESCRIPTION

### Definitions

Unless defined otherwise, all technical and scientific terms used herein have the same meaning as commonly understood by one of ordinary skill in the art.

The term “connected” as used herein generally refers to pieces which may be joined or linked together.

The term “coupled” as used herein generally refers to pieces which may be used operatively with each other or joined or linked together, with or without one or more intervening members.

The term “directly” as used herein generally refers to one structure in physical contact with another structure, or, when used in reference to a procedure, means that one process affects another process or structure without the involvement of an intermediate step or component.

Unless otherwise specifically defined herein the terms “about” or “substantially” when used in combination with a number or amount or quantity may generally refer to +/−10% of the referred to number or amount or quantity.

### Embodiments

In some embodiments, systems presented herein may allow for a pressure reduction in a braking system during a collision. The braking system may include a hydraulic braking system and/or an air braking system. Pressure reduction in a braking system during a collision may give a brake pedal of the braking system additional travel time and/or distance, before directly impacting any obstructions in the vehicle (e.g., the floor pan). The system may reduce pressure with a controlled backpressure. Consequently, the braking pedal peak back-forces are reduced and spread over a longer time period, therefore reducing the applied peak “g” forces to a driver's leg.

Typically in most vehicles the brake pedal does not travel all the way to the floor pan of the vehicle during normal use of the brake system. However, the herein described system allows the brake pedal to travel beyond the normally designated stopping point in a controlled manner In some embodiments, the extra travel distance between the brake pedal “hard stop” position and floor pan, allows the airbag and seatbelts additional time to retard the forward driver body motion. The controlled manner is a critical difference between the currently described system and other disclosed systems. Other systems may bleed off brake fluid during an accident but they do not do this in a controlled manner Other systems allow the brake fluid pressure to drop so quickly that the brake pedal still slams into the floor pan in such a manner as to result in significant injuries during a collision.

Systems described herein may include several advantages including reasonable cost in both new vehicle designs and retrofit kits for existing vehicles. Systems described herein may prevent overpressures in the braking system. Overpressure in braking systems may lead to component failures in the braking system. Systems described herein may be incorporated into either a hydraulic master cylinder, a hydraulic-air system.

In some embodiments, no external momentum sensors and/or “g” force sensors are required. The reduction in pedal force may be controlled by a valve implemented force reduction in the braking system.

In some embodiments, the design implementations are applicable to hydraulic fluid, air hydraulic, and air braking systems. Embodiments discussed herein may be applicable to all three systems.

### Design Implementation Examples

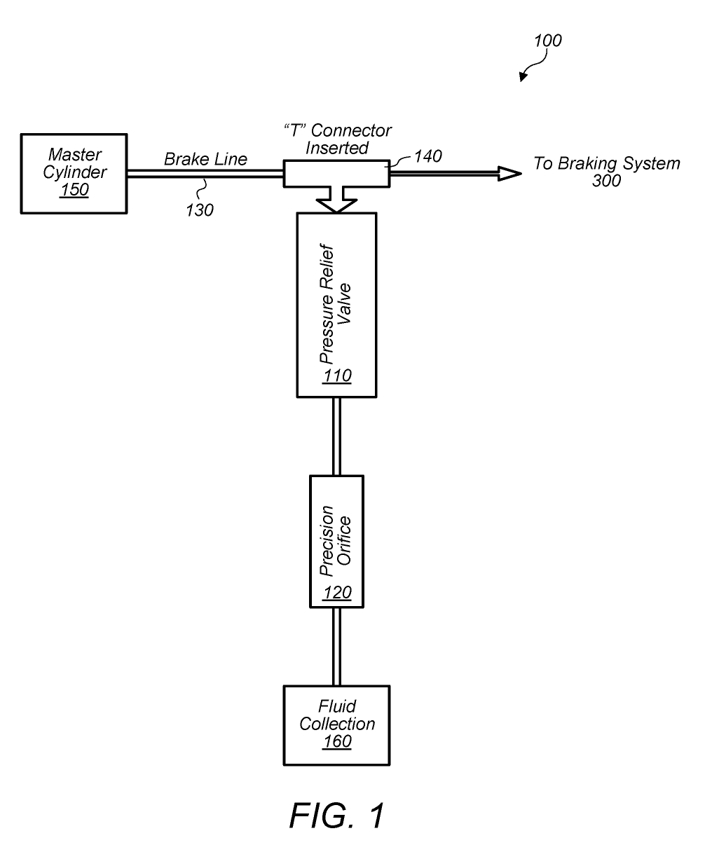

FIG. 1 depicts an embodiment of a system 100 for reducing backpressure in a braking system 300 including a valve 110 (e.g., a pressure relief valve) and a sized opening 120. The valve 110 may be coupled at any point along a pressurized brake line 130. The valve 110 may be coupled to the brake line using a fitting 140 (e.g., either during vehicle production or as part of an after market kit). A fitting may include a “T” fitting.

In some embodiment, a vehicle may include a system 100 installed for each master cylinder 150 of the vehicle. Current vehicle designs usually have two master cylinders, one for the front brakes and one for the rear brakes. Some braking systems use a cross-coupled configuration, wherein one master cylinder controls the left front and right rear wheel, and the other master cylinder controls the right front wheel and left rear wheel. So, each would have a system 100 coupled/installed for each master cylinder. In some embodiments, a fitting may be coupled to a brake line for each master cylinder and coupled to a common valve (although in such cases the sized opening may have to be adjusted to accommodate multiple brake lines bleeding at once so the backpressure is precisely controlled).

The valve may be coupled to the brake line (e.g., using the fitting). The valve may open in response to a trigger. The trigger may include a predetermined pressure. In some embodiments, the trigger pressure point of the valve may be pre-set at a value higher than required to lock the brakes. In some embodiments, a valve may include a rupture disk. Rupture disks may be advantageous in that there is less chance of leakage and/or less chance of corrosion (e.g., of seals associated with a more traditional valve). Rupture disks have a faster response time than pressure relief valves, easier to maintain and lower cost. A rupture disk may be configured to rupture under a specific pressure range (e.g., about 1500 to about 2000 psi).

In some embodiments, the sized opening may be coupled to the valve. In some embodiments, the sized opening may be formed as part of the valve. However, for ease of manufacturing and/or for adapting the system to fit different types of vehicles the sized opening may be coupled to the valve and not be formed as a single unit. The brake fluid from the valve passes through a precision sized opening whose flow rate is designed to reduce brake fluid pressure in the braking system versus time. But the flow rate of the brake fluid may not fall below a value required to stop the vehicle. In some embodiments, two valves may be coupled in series to provide redundancy. The opening may have an area of about 0.0025 in² or about 0.002 in² to about 0.003 in². The opening may have a diameter of between about 0.050 inches and about 0.061 inches.

In some embodiments, the released brake fluid may collect in a container 160. The amount of brake fluid released from the system is what is contained in the hydraulic pressure chamber, and is typically much less than a full master cylinder brake reservoir. In some embodiments, the released brake fluid may be routed back into the brake cylinder reservoir.

In some embodiments, the orifice flow rate, versus time, may be designed for a particular vehicle master brake cylinder design, the free travel space beneath the brake pedal to the floor pan, and the weight of the vehicle. The goal is to provide controlled brake pedal backpressure as the pedal proceeds toward the floor pan. Too high a flow rate results in the brake pedal reaching the floor pan too quickly resulting in a greater impact and increased probability of injury and/or greater injury. Too low a flow rate results and the brake pedal does not travel as far as it could within a given vehicle resulting in an increased probability of injury and/or greater injury relative to a system which allows the brake pedal to use all of the available distance in the allotted time period of a collision. In some embodiments, adjustable flow rates, as a function of pressure in the orifice design, is desirable to optimize the brake pedal backpressure versus time curve. A method may include allowing the fluid in the pressurized brake line to flow through a precision sized opening accessible through the opened valve. The sized opening may reduce a fluid pressure in the pressurized brake line within a predetermined time period. The sized opening may be dimensioned to allow for a flow rate of the fluid conveying through the sized opening such that the fluid pressure reduces over the predetermined time period while allowing for using a maximum amount of a distance. The distance may be from the brake pedal (in an unactivated resting state) to a floor pan of the vehicle. It should be noted that typically in a properly functioning braking system the brake pedal may travel up to about 1 inch and is due to the small clearance that the brake pads have in movement toward the brake disks, or the brake shoes movement toward the brake drums in older systems. The predetermined time period may include a duration of a vehicle collision. The predetermined period of time may be from about 80 to about 100 milliseconds. In some embodiments, the predetermined period of time may be from about 50 milliseconds to about 150 milliseconds.

In some embodiments, a sized opening may be adjustable such that the sized opening/system may be used for different sized vehicles and/or different sized master cylinders.

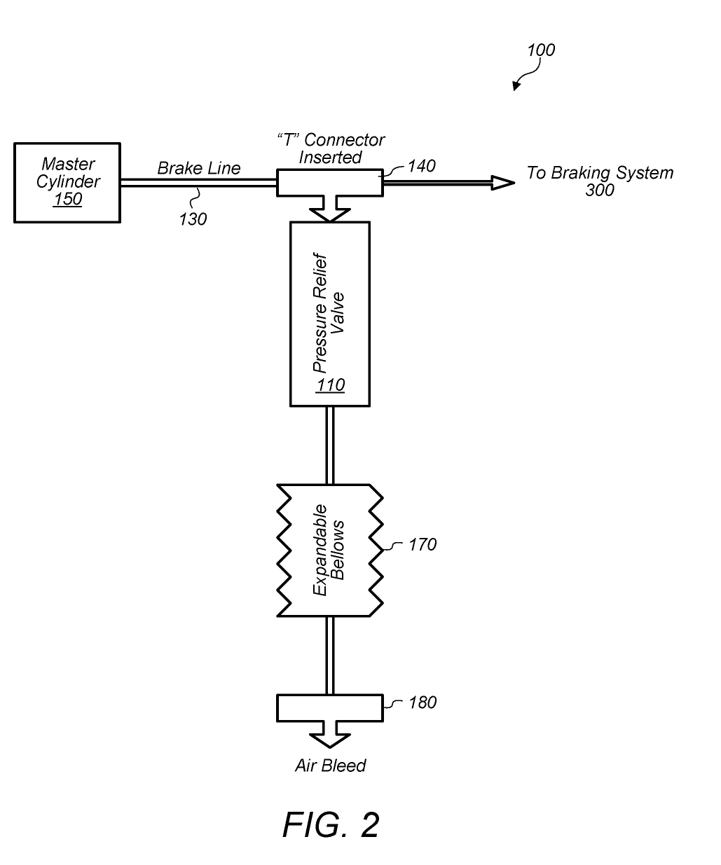

FIG. 2 depicts an embodiment of a system 100 for reducing backpressure in a braking system 300 including a valve 110 (e.g., a pressure relief valve) and an expandable bellows 170. This embodiment includes some similar design features as those described in FIG. 1 except the size opening is replaced with a bellows designed to expand under the extreme braking fluid pressures. The bellows may form an expansion chamber that increases in volume with pressure, and therefor reduces excessive brake fluid pressure buildup. The bellows chamber may be designed with sufficient strength so the expansion does not harm the bellows. The bellows may return to its normal unexpanded state after the pressure is reduced.

In some embodiments, this is a closed system and no brake fluid, or air, is lost from the braking system. In some embodiments, a bleed valve 180 is coupled to the bellows 170. The bleed valve may ensure no residual air is in the bellows chamber. Advantages of such a system may include that no brake fluid intentionally escapes the system. The bellows design of expansion versus pressure may be customized for different vehicles sizes and/or different master cylinders.

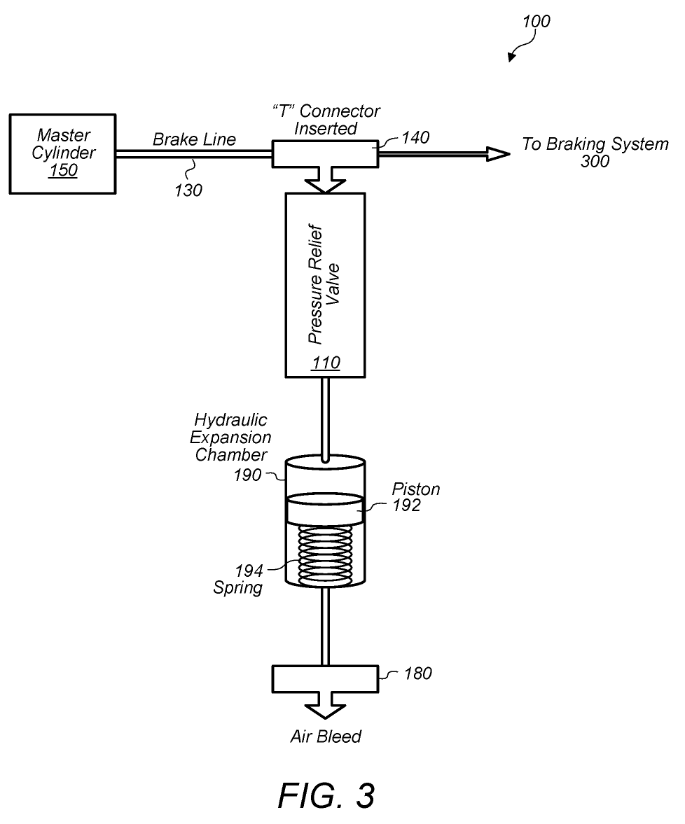

FIG. 3 depicts an embodiment of a system 100 for reducing backpressure in a braking system 300 including a valve 110 (e.g., a pressure relief valve) and hydraulic expansion cylinder 190. This embodiment includes some similar design features as those described in FIGS. 1-2 except the bellows of FIG. 2 is replaced with a hydraulic cylindrical chamber 190. In some embodiments, the hydraulic cylindrical chamber 190 has a spring loaded sealed piston including a piston 192 and a spring 194. The spring constant may be designed to increase cylinder volume under pressure, which controls the fluid pressure buildup. In some embodiments, a bleed valve 180 is coupled to hydraulic expansion cylinder 190 to remove air from the system.

The embodiment depicted in FIG. 3 has the advantage of using a non-linear spring constant to adjust the fluid pressure versus time. In comparison to the two previous implementations, the spring characteristics may be easier to customize for vehicle type and easier to maintain and/or replace over the vehicle life. The spring embodiment may be adjusted by using different springs with different force constants to adjust for different sized vehicles.

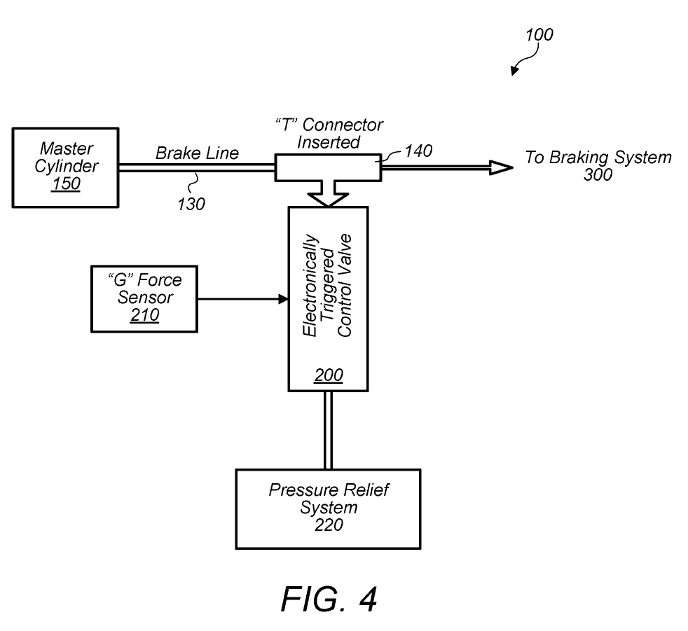

FIG. 4 depicts an embodiment of a system 100 for reducing pedal backpressure in a braking system 300 including an electronically triggered valve 200. In some embodiments, systems described herein may employ instead of a mechanical valve an electronically triggered valve 200. In some embodiments, the electronic valve 200 may be triggered by a “g” force sensor 210. The“g” force sensors are typically used to trigger airbag release. Use of the “g” force sensor, to trigger the valve, improves control over the initialization process. Most airbags are designed to deploy at 6 g's. Simulations and testing will determine the best values matched to the vehicle. The embodiment depicted in FIG. 4 may include a pressure relief system 220 (e.g., as described herein in FIGS. 1-3).

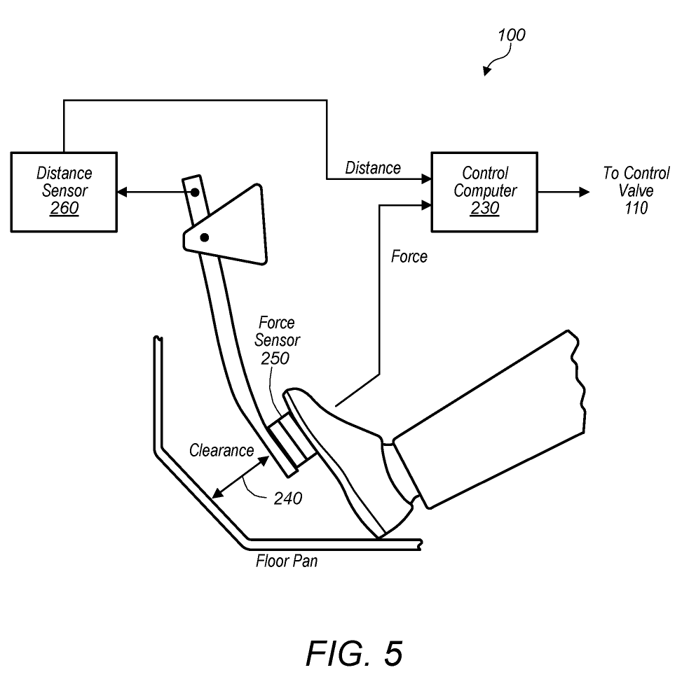

FIG. 5 depicts an embodiment of a system 100 for reducing backpressure in a braking system 300 using computer 230 control based on pedal motion 240 and a force sensor 250. With the universal use of computers in vehicles, the brake fluid pressure relief system is even more viable. Precise braking control may be achieved by monitoring the brake pedal backpressure and pedal travel distance. These measurements may be fed to the vehicle computer, and calculations rapidly preformed to control the pressure release mechanism. The system 100 may include a distance sensor 260 which constantly determines the clearance 240 of the brake pedal. The system 100 may use the force sensor 250 to determine the force applied to the brake pedal. All of this information may be routed to the vehicle's onboard computer to determine if or when the control valve will be opened. The computer control program is customized for each vehicle and it's particular characteristics.

In some embodiments, systems described herein may be installed in a vehicle during production. In some embodiments, systems described herein may be installed after a vehicle is assembled as an aftermarket kit (e.g., by a mechanic at a shop, car dealer, or a vehicle owner). A kit may include a fitting (e.g., a “T” connector) and a control valve/a sized opening. The kit may include a fluid collection container.

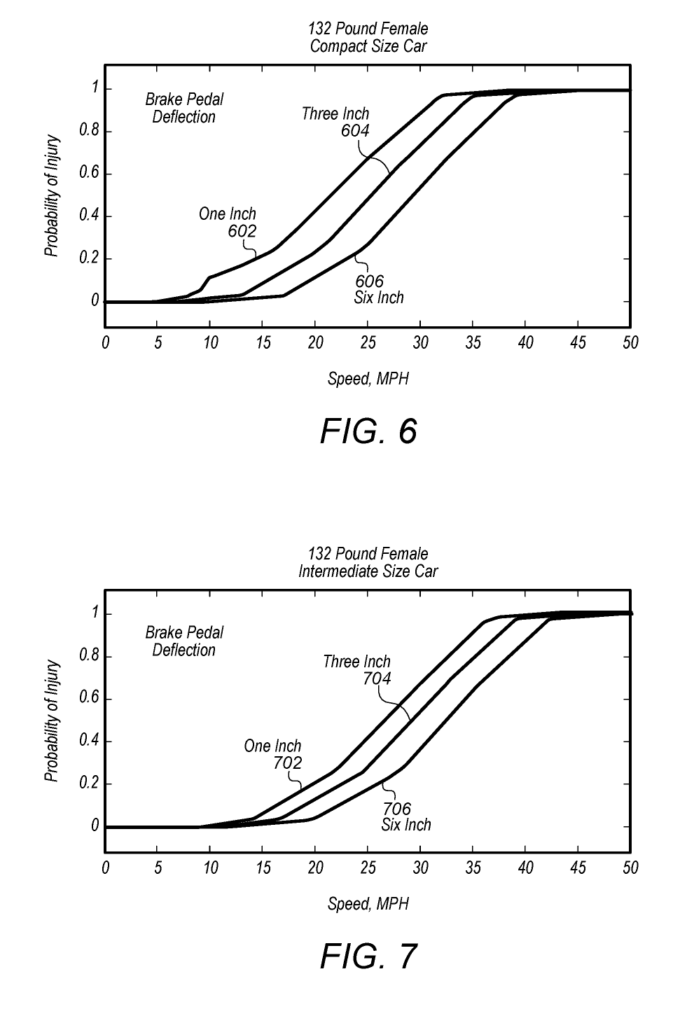

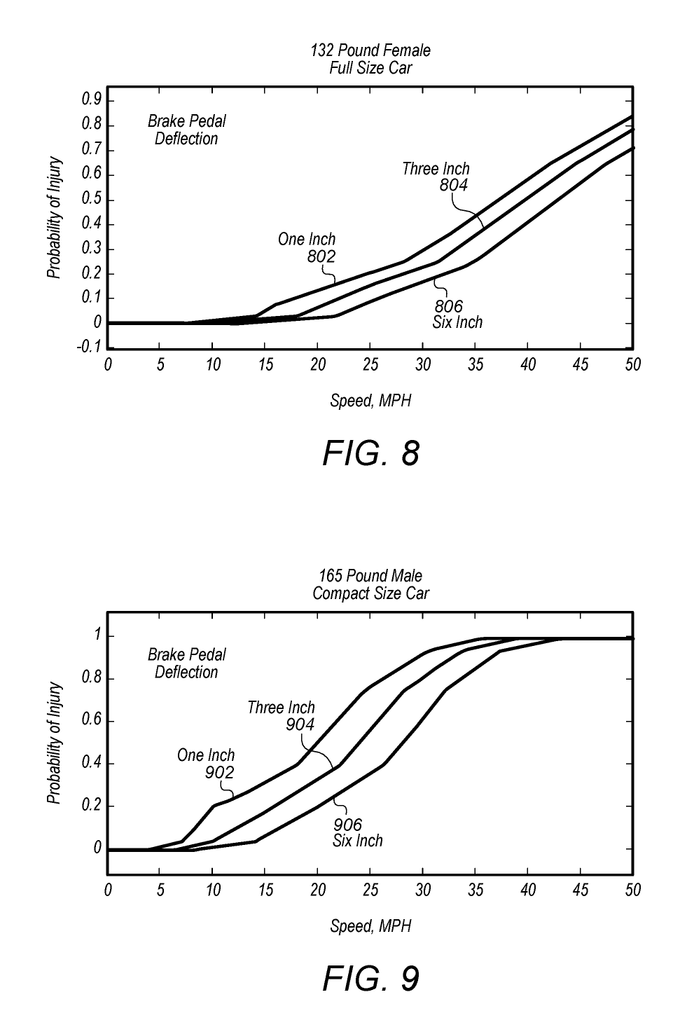

In order to demonstrate the utility of the herein describe methods and systems Mathworks® SIMULINK software was employed to model the effects of changing an amount of a brake pedal deflection on a probability of injury on a driver of a vehicle. The model is based upon the additional allowed brake pedal travel added to the vehicle crush distance versus vehicle speed in MPH. If the braking back pressure is not controlled the foot still slams to the floor board in an uncontrolled manner Some reduction on the foot pressure may result from the seat belt/shoulder harness taking hold before the foot reaches the floor pan. FIGS. 6-8 depict depicts a calculated probability of injury relative to speed of a compact, intermediate, and full size vehicles involved in a collision for a 132 pound female driver as a brake pedal deflection is increased using, for example, the system described herein. Lines 602, 702, and 802 depict the effect of a one-inch brake pedal deflection upon probability of injury upon the driver. Lines 604, 704, and 804 depict the effect of a three-inch brake pedal deflection upon probability of injury upon the driver. Lines 606, 706, and 806 depict the effect of a six-inch brake pedal deflection upon probability of injury upon the driver.

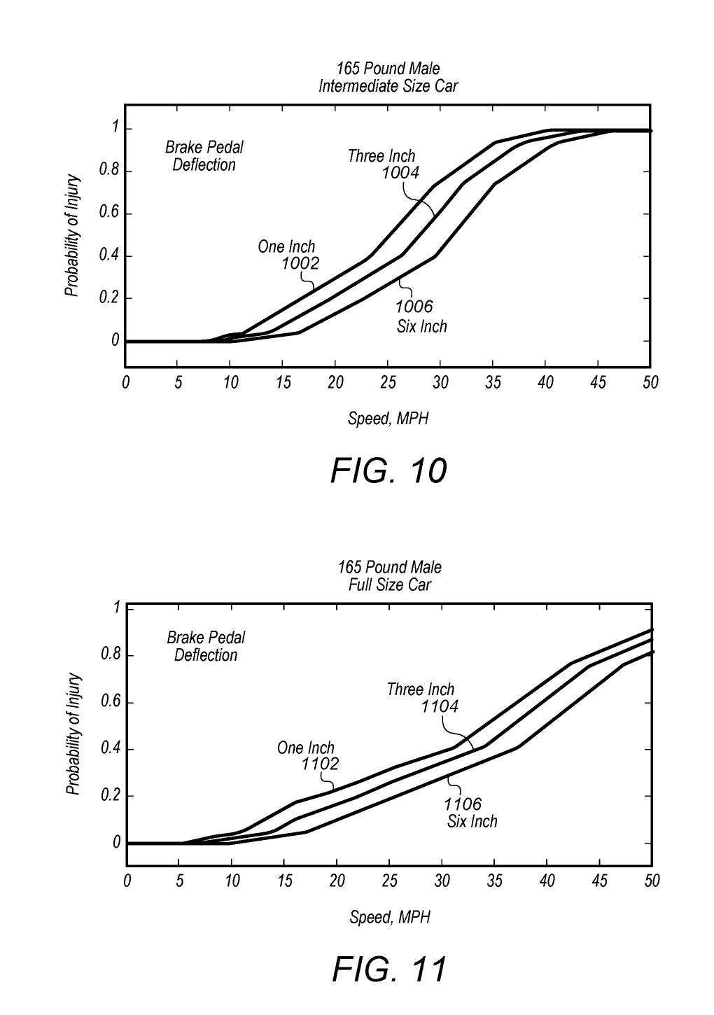

FIGS. 9-11 depict depicts a calculated probability of injury relative to speed of a compact, intermediate, and full size vehicles involved in a collision for a 165 pound male driver as a brake pedal deflection is increased using, for example, the system described herein. Lines 902, 1002, and 1102 depict the effect of a one-inch brake pedal deflection upon probability of injury upon the driver. Lines 904, 1004, and 1104 depict the effect of a three-inch brake pedal deflection upon probability of injury upon the driver. Lines 906, 1006, and 1106 depict the effect of a six-inch brake pedal deflection upon probability of injury upon the driver. The greater decrease in probability of injury is probably due to the increased bone strength in a male driver.

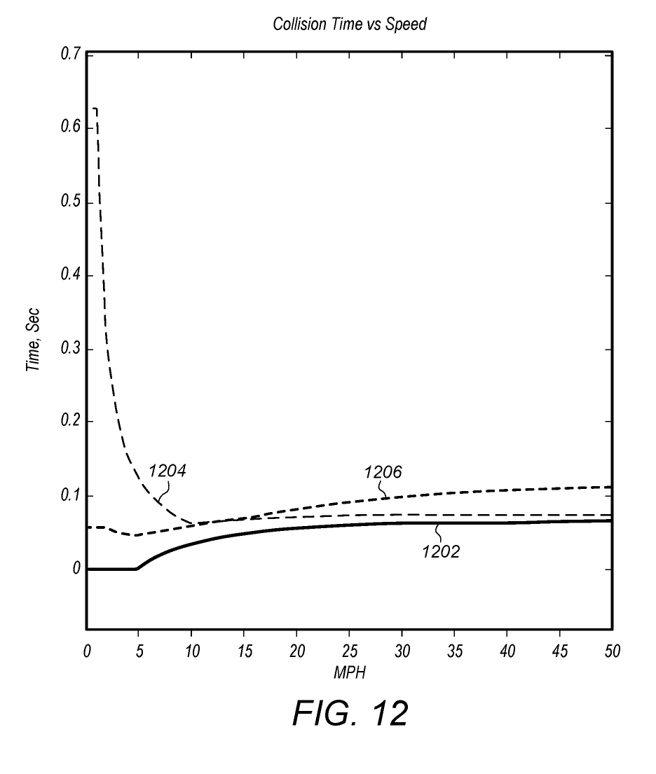

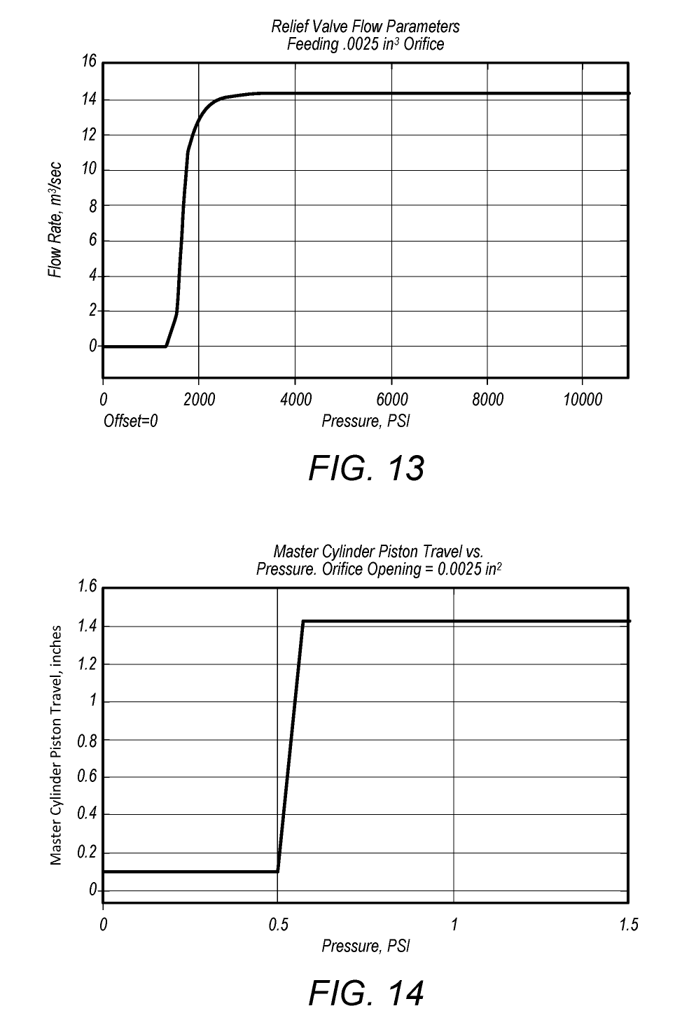

FIG. 12 depicts a calculated time of collision relative to a speed of a variety of differently sized vehicles including a compact vehicle 1202 (Honda Civic), an intermediate sized vehicle 1204 (Chevrolet Vega), and a full sized vehicle 1206 (full size GM). As can be see a duration of a collision for all of the vehicles falls within a narrow range for most speeds. The collision time may fall within a window of about 30 to about 130 milliseconds, about 50 to about 110 milliseconds, or about 80 to about 100 milliseconds. FIG. 13 depicts a calculated relief valve flow (coupled to a 0.0025 in². opening) depicted as a flow rate (in³/sec) verses pressure (psi). FIG. 14 depicts a calculated master cylinder piston travel (in.) verses time (sec.) using an opening that is 0.0025 in².

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method of reducing injuries as a result of vehicle collisions, comprising:
opening a valve in a pressurized brake line of a brake system of a vehicle in response to a trigger, wherein the trigger comprises a set pressure value of a fluid in the pressurized brake line;
allowing the fluid in the pressurized brake line to flow through a precision sized opening accessible through the opened valve, wherein the sized opening reduces a fluid pressure in the pressurized brake line within a predetermined time period; and
reducing back pressure on a brake pedal coupled to the pressurized brake line.

2. The method of claim 1, wherein the set pressure value is greater than a pressure value required to lock the brakes of the vehicle.

3. The method of claim 1, wherein the predetermined time period is about 80 to about 100 milliseconds.

4. The method of claim 1, wherein the sized opening is dimensioned to allow a flow rate of the fluid conveying through the sized opening such that the fluid pressure reduces over the predetermined time period which allows for using a maximum amount of a distance, wherein the distance is from the brake pedal to a floor pan of the vehicle, and wherein the predetermined time period is a duration of a vehicle collision.

5. The method of claim 1, wherein the brake system comprises a hydraulic braking system and/or an air braking system.

6. The method of claim 1, further comprising inhibiting the flow of the fluid through the sized opening to the extent that stopping the vehicle is not inhibited.

7. The method of claim 1, further comprising collecting the fluid conveyed through the sized opening in a container hydraulically coupled to the valve.

8. The method of claim 1, further comprising collecting the fluid conveyed through the sized opening in a brake cylinder reservoir hydraulically coupled to the valve.

9. The method of claim 1, further comprising reducing backpressure on a brake pedal coupled to the pressurized brake line in a controlled manner.

10. The method of claim 1, wherein the sized opening allows for a flow rate of the fluid through the sized opening to be adjustable as a function of pressure.

11. The method of claim 1, further comprising coupling the valve to the pressurized brake line using a “T” fitting.

12. A system for reducing injuries as a result of vehicle collisions, comprising:
a valve coupled, during use, to a pressurized brake line of a brake system of a vehicle, wherein the valve opens, during use, in response to a trigger, and wherein the trigger comprises a set pressure value of a fluid in the pressurized brake line; and
a sized opening which allows, during use, the fluid in the pressurized brake line to flow through the sized opening accessible through the opened valve, wherein the sized opening reduces a fluid pressure in the pressurized brake line within a predetermined time period when opened reducing back pressure on a brake pedal coupled to the pressurized brake line.

13. The system of claim 12, wherein the set pressure value is greater than a pressure value required to lock the brakes of the vehicle and results from collision forces.

14. The system of claim 12, wherein the sized opening is dimensioned to allow a flow rate of the fluid conveying through the sized opening such that the fluid pressure reduces over the predetermined time period, but not below the pressure to stop the vehicle.

15. The system of claim 12, wherein the sized opening is dimensioned to allow a flow rate of the fluid conveying through the sized opening such that the fluid pressure reduces over the predetermined time period which allows for using a maximum amount of a distance, wherein the distance is from the brake pedal to a floor pan of the vehicle, and wherein the predetermined time period is a duration of a vehicle collision.

16. The system of claim 12, wherein the brake system comprises a hydraulic braking system and/or an air braking system.

17. The system of claim 12, wherein the sized opening inhibits, during use, the flow of the fluid through to the extent that stopping the vehicle is not inhibited.

18. The system of claim 12, further comprising a container, hydraulically coupled to the valve during use, which collects, during use, the fluid conveyed through the sized opening.

19. The system of claim 12, further comprising a brake cylinder reservoir, same coupled to the valve during use, which collects, during use, the fluid conveyed through the sized opening.

20. The system of claim 12, wherein the sized opening reduces, during use, back pressure on a brake pedal coupled to the pressurized brake line in a controlled manner.

21. The system of claim 12, wherein the sized opening allows for a flow rate of the fluid through the sized opening to be adjustable as a function of pressure.

22. The system of claim 12, further comprising a “T” fitting which couples, during use, the valve to the pressurized brake line.
